(19) United States
(12) Patent Application Publication
(10) Pub. No.: US 2024/0319400 A1
(43) Pub. Date: Sep. 26, 2024

(54) Magnetotelluric Impedance Estimation Method

(71) Applicant: Central South University, Changsha City, Hunan Province (CN)

(72) Inventors: Hongchun Yao, Changsha City (CN); Rujun Chen, Changsha City (CN); Zhenwei Guo, Changsha City (CN); Ruijie Shen, Changsha City (CN); Yan Wu, Changsha City (CN); Bochen Wang, Changsha City (CN); Siwen Chen, Changsha City (CN); Shuang Cheng, Changsha City (CN)

(21) Appl. No.: 18/610,408

(22) Filed: Mar. 20, 2024

(30) Foreign Application Priority Data
Mar. 20, 2023 (CN) 2023102708540

(51) Int. Cl. G01V 3/38

(52) U.S. Cl. CPC G01V 3/38

(57) ABSTRACT

A magnetotelluric impedance estimation method is provided, belonging to the field of exploration. The method specifically includes the following steps: Step 1, performing Fourier transform on electromagnetic time series data of a plurality of electromagnetic field components to obtain a frequency spectrum array corresponding to each of electromagnetic field components; Step 2, identifying an interference frequency of each of electromagnetic field components according to the frequency spectrum array; Step 3, merging the interference frequency and a deviation value; Step 4, attenuating the frequency spectrum array using the merged interference frequency and deviation value; Step 5, recovering the electromagnetic time series data using the attenuated frequency spectrum array, so as to obtain a transform result; and Step 6, performing magnetotelluric impedance estimation according to the transform result. By the scheme disclosed, the adaptability and accuracy of magnetotelluric impedance estimation are improved.

### CROSS-REFERENCE TO RELATED APPLICATION

This patent application claims the benefit and priority of Chinese Patent Application No. 2023102708540 filed with the China National Intellectual Property Administration on Mar. 20, 2023, the disclosure of which is incorporated by reference herein in its entirety as part of the present application.

### TECHNICAL FIELD

The embodiments of the present disclosure relate to the field of exploration, and in particular to a magnetotelluric impedance estimation method.

### BACKGROUND

Magnetotelluric method is an exploration method for detecting underground targets using natural electromagnetic signals, which is widely used in the fields of mineral exploration, oil and gas exploration, engineering exploration and disaster monitoring. The magnetotelluric method has the advantages of deep exploration, convenient construction and high exploration efficiency, but the magnetotelluric method is easily affected by electromagnetic signal interference, especially in areas with frequent human activities. In view of the increasingly serious electromagnetic interference, scholars in China and at abroad have adopted various denoising methods. Gamble et al. proposed and used the remote reference denoising method for the first time, which can suppress the irrelevant noise in collected signals. Egbert et al. used the improved weighted least squares algorithm for impedance estimation, and compared the effects of related algorithms. Tang Jingtian et al. used mathematical morphological filtering method to denoise in time series, which can eliminate some strong interference noises with defined morphologies. Garcia et al. used continuous wavelet transform to select the data of AMT dead band, which solves the problem of weak signals of the dead band. Tang Jingtian et al. introduced Hilbert-Huang transform into magnetotelluric data processing to eliminate some low-frequency interference by empirical mode decomposition. These denoising methods can achieve some results for certain data types, but the processing effect for strong interference data with long duration, strong interference amplitude and obvious periodicity is unsatisfactory.

Therefore, there is an urgent need for a magnetotelluric impedance estimation method with high detection adaptability and accuracy.

### SUMMARY

In view of this, a magnetotelluric impedance estimation method is provided by embodiments of the present disclosure, which at least partially solves the problem of poor detection adaptability and accuracy in the prior art.

A magnetotelluric impedance estimation method provided by an embodiment of the present disclosure includes following steps:
Step 1, performing Fourier transform on electromagnetic time series data of multiple electromagnetic field components to obtain a frequency spectrum array corresponding to each of electromagnetic field components;
Step 2, identifying an interference frequency of each of electromagnetic field components according to the frequency spectrum array;
Step 3, merging the interference frequency and a deviation value;
Step 4, attenuating the frequency spectrum array using the merged interference frequency and deviation value;
Step 5, recovering the electromagnetic time series data using the attenuated frequency spectrum array, so as to obtain a transform result; and
Step 6, performing magnetotelluric impedance estimation according to the transform result.

According to a specific implementation of the embodiments of the present disclosure, the electromagnetic field components are at least two of Ex, Ey, Hx, Hy and Hz. Ex is an electric field signal component in an X direction, Ey is an electric field signal component in a Y direction, Hx is a magnetic field signal component in the X direction, Hy is a magnetic field signal component in the Y direction, Hz is a magnetic field signal component in a Z direction, the X direction and the Y direction are horizontal directions and orthogonal to each other, and the Z direction is a vertical direction.

The electromagnetic time series data are sampling point data of each of electromagnetic field components collected according to a predetermined sampling rate.

According to a specific implementation of the embodiments of the present disclosure, Step 2 specifically includes following steps:
Step 2.1, computing a power spectrum array Pi(w) of each of electromagnetic field components according to the frequency spectrum array;
Step 2.2, filtering Pi(w) using a median filtering method to obtain a filtered data Pi1(w);
Step 2.3, calculating a difference ΔPi(w) between Pi(w) and Pi1(w); and
Step 2.4, selecting all interference frequency arrays Wr greater than a threshold Y0 from ΔPi(w), and recording ΔPi(w) corresponding to Wr in a deviation value Dr.

According to a specific implementation of the embodiments of the present disclosure, Step 3 specifically includes following steps:
Step 3.1, merging the interference frequency array Wr of each of electromagnetic field components into an array Ws by union, and only keeping one of same frequency values in Ws; and
Step 3.2, calculating a synthetic deviation value of each frequency according to an order of frequencies in the Ws array, and storing the synthetic deviation values in an array Ds in sequence.

According to a specific implementation of the embodiments of the present disclosure, the synthetic deviation value corresponds to a maximum deviation value of all components of the frequency.

According to a specific implementation of the embodiments of the present disclosure, Step 4 specifically includes following steps:
Step 4.1, acquiring a number N of elements in an interference frequency Ws, and initializing i=1;
Step 4.2, acquiring an i-th frequency Wi in the Ws and an i-th deviation value Di in the Ds;
Step 4.3, calculating an attenuation coefficient Ri using the deviation value Di;
Step 4.4, attenuating a frequency spectrum value Ai corresponding to each electromagnetic field component frequency Wi of the electromagnetic field, that is, Ai=Ai*Ri; and
Step 4.5, determining a value of i, in a case that i is equal to N, completing an attenuation of each frequency spectrum array, in a case that i is unequal to N, setting i=i+1, and proceeding to Step 4.2 for continuous processing.

According to a specific implementation of the embodiments of the present disclosure, an attenuation frequency value of each of electromagnetic field components is the same, and an attenuation coefficient at the same frequency of each of electromagnetic field components is the same.

According to a specific implementation of the embodiments of the present disclosure, Ri and Di have an inverse correlation, and calculation formula of Ri is Ri=10^{-Di}.

A magnetotelluric impedance estimation solution provided by the embodiments of the present disclosure includes the following steps: Step 1, performing Fourier transform on electromagnetic time series data of multiple electromagnetic field components to obtain a frequency spectrum array corresponding to each of electromagnetic field components; Step 2, identifying an interference frequency of each of electromagnetic field components according to the frequency spectrum array; Step 3, merging the interference frequency and a deviation value; Step 4, attenuating the frequency spectrum array using the merged interference frequency and deviation value; Step 5, recovering the electromagnetic time series data using the attenuated frequency spectrum array, so as to obtain a transform result; and Step 6, performing magnetotelluric impedance estimation according to the transform result.

The present disclosure has the beneficial effects that:
1. A strong interference signal in an magnetotelluric signal can be automatically identified, manual analysis and processing of massive data are saved, and data processing efficiency is improved.
2. A periodic strong interference signal in the magnetotelluric signal can be suppressed, and the accuracy of magnetotelluric impedance estimation is improved.
3. An inverse correlation algorithm between the frequency attenuation coefficient and the deviation value is used, the greater the interference is, the stronger the suppression is, and the effect of adaptive denoising is achieved.
4. The multi-component attenuation method with the same frequency and coefficient ensures that the calculation result is free of distorting.

### BRIEF DESCRIPTION OF THE DRAWINGS

To describe the technical solutions of the embodiments of the present disclosure more clearly, the following briefly introduces the accompanying drawings required for describing the embodiments. Apparently, the accompanying drawings in the following description show merely some embodiments of the present disclosure, and those of ordinarily skilled in the art may still derive other drawings from these accompanying drawings without creative efforts.

FIG. 1 is a flowchart of a magnetotelluric impedance estimation method according to an embodiment of the present disclosure;

FIG. 2 is a flowchart showing a merging of interference frequencies and deviation values of four components according to an embodiment of the present disclosure; and

FIG. 3 is a flowchart showing an attenuation of a single component spectrum according to an embodiment of the present disclosure.

### DETAILED DESCRIPTION OF THE EMBODIMENTS

The embodiments of the present disclosure are described in detail below with reference to the accompanying drawings.

The following describes the implementations of the present disclosure through specific examples, and those skilled in the art can easily understand other advantages and effects of the present disclosure from the contents disclosed in this specification. Apparently, the described embodiments are merely a part rather than all of the embodiments of the present disclosure. The present disclosure may be implemented or applied in various other specific implementations, and the details of the specification may also be variously modified or changed based on different viewpoints and applications without departing from the spirit of the present disclosure. It should be noted that the following embodiments and features in the embodiments may be combined with each other without conflicting. All other embodiments obtained by a person of ordinarily skilled in the art based on the embodiments of the present disclosure without creative efforts shall fall within the protection scope of the present disclosure.

It should be noted that the following description sets forth various aspects of the embodiments within the scope of the appended claims. It should be apparent that the aspects described herein may be embodied in a variety of forms and that any specific structure and/or function described herein is merely illustrative. Based on the present disclosure, those skilled in the art should appreciate that one aspect described herein may be implemented independently of any other aspects and two or more of these aspects may be combined in various ways. For example, a device may be implemented and/or a method may be practiced using any number of the aspects set forth herein. In addition, such a device may be implemented and/or such a method may be practiced using other structures and/or functionalities than one or more of the aspects set forth herein.

It should also be noted that the illustrations in the following embodiments merely illustrate the basic concept of the present disclosure in a schematic manner, and only the components related to the present disclosure are shown in the drawings, instead of showing the drawings according to the number, shape and size of component in actual implementation. The shape, number, and scale of the component in an actual implementation of the present disclosure may be changed randomly, and the layout pattern of the component may also be more complex.

In addition, in the following description, specific details are provided to facilitate a thorough understanding of the examples. However, those skilled in the art should appreciate that the aspects can be practiced without these specific details.

A magnetotelluric impedance estimation method is provided by the embodiment of the present disclosure, which can be applied to the process of detecting underground targets by using natural electromagnetic signals in scenes such as mineral exploration, oil and gas exploration, engineering exploration and disaster monitoring.

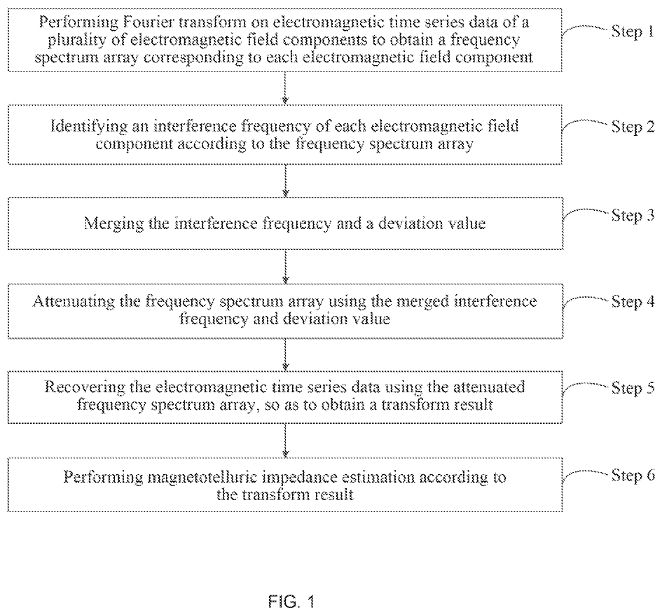

FIG. 1 is a flowchart of a magnetotelluric impedance estimation method according to an embodiment of the present disclosure. As shown in FIG. 1, the method mainly includes the following steps:

Step 1. Fourier transform is performed on electromagnetic time series data of a plurality of electromagnetic field components to obtain a frequency spectrum array corresponding to each of electromagnetic field components.

In some embodiments, the electromagnetic field components are at least two of Ex, Ey, Hx, Hy and Hz. Ex is an electric field signal component in an X direction, Ey is an electric field signal component in a Y direction, Hx is a magnetic field signal component in the X direction, Hy is a magnetic field signal component in the Y direction, Hz is a magnetic field signal component in a Z direction, the X direction and the Y direction are horizontal directions and orthogonal to each other, and the Z direction is a vertical direction.

The electromagnetic time series data are sampling point data of each of electromagnetic field components collected according to a predetermined sampling rate.

For example, a total of four electromagnetic field components of the magnetotelluric method need to be processed, which are Ex, Ey, Hx and Hy, and the time series data are X1, X2, X3 and X4, respectively, the time series length is N, and the sampling rate is S, then the Fourier transform with the length of N can be respectively performed on X1, X2, X3 and X4 to obtain frequency spectrum arrays Y1, Y2, Y3 and Y4 of the four electromagnetic field components.

Step 2. An interference frequency of each of electromagnetic field components is identified according to the frequency spectrum array.

Further, Step 2 specifically includes the following steps:
Step 2.1, computing a power spectrum array Pi(w) of each of electromagnetic field components according to the frequency spectrum array;
Step 2.2, filtering Pi(w) using a median filtering method to obtain a filtered data Pi1(w);
Step 2.3, calculating a difference ΔPi(w) between Pi(w) and Pi1(w); and
Step 2.4, selecting all interference frequency arrays Wr greater than a threshold Y0 from ΔPi(w), and recording ΔPi(w) corresponding to Wr in a deviation value Dr.

During specific implementation, the power spectrum arrays P1, P2, P3 and P4 of the four electromagnetic field components can be calculated using the obtained frequency spectrum arrays, and the formula for converting a frequency spectrum value Yi of the i-th frequency into the power spectrum value Pi is Pᵢ=20×log₁₀ Yᵢ, and the power spectrum arrays P1, P2, P3 and P4 are copied into four newly applied power spectrum arrays P11, P21, P31 and P41, and the P11, P21, P31 and P41 are performed by median filtering, respectively, where the filtering length FL=N/30. Differences between the unfiltered power spectrums and the filtered power spectrums are calculated and stored in differential arrays ΔP1, ΔP2, ΔP3 and ΔP4, respectively. Then, values with element values greater than a threshold Y0 are selected from the ΔP1, ΔP2, ΔP3 and ΔP4 arrays and stored in a Dr[i] array (i=0-3), respectively, and index values of the elements in the differential array are stored in a Wr[i] array (i=0-3), respectively. Preferably, Y0=10 is generally taken.

Step 3. The interference frequency and a deviation value are merged.

Further, Step 3 specifically includes the following steps:
Step 3.1, merging the interference frequency array Wr of each of electromagnetic field components into an array Ws by union, and only keeping one of same frequency values in Ws; and
Step 3.2, calculating a synthetic deviation value of each frequency according to an order of frequencies in the Ws array, and storing the synthetic deviation values in an array Ds in sequence.

In some embodiments, the synthetic deviation value corresponds to a maximum deviation value of all components of the frequency.

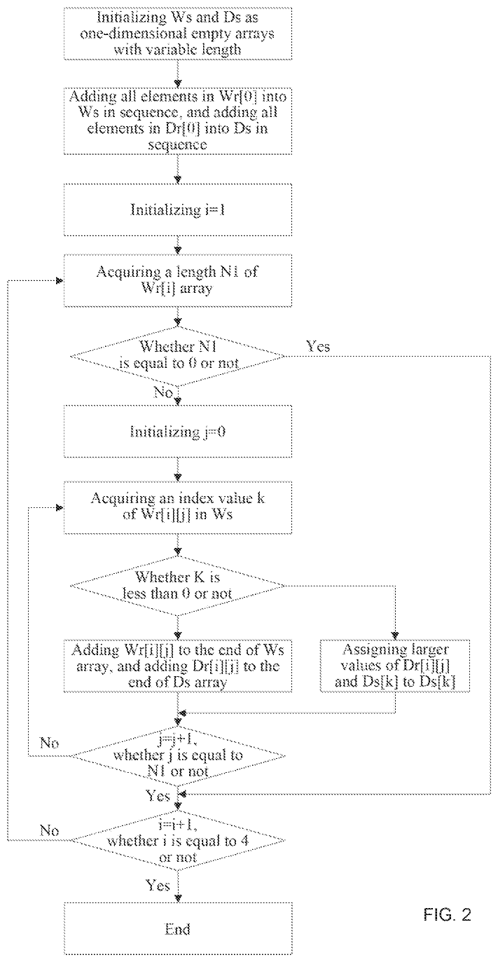

During specific implementation, as shown in FIG. 2, four Wr[i] arrays can be merged into an array Ws, and then four Dr[i] arrays can be merged into a Ds array to complete the merger of interference frequency and deviation value. Finally, the merged frequency array and the deviation value array are Ws and Ds. Wr and Dr in the figure are two-dimensional arrays, which are configured to store the interference frequency values and deviation values of four components, respectively. “Acquiring an index value k of Wr[i][j] in Ws” means to find a value of Wr[i][j] in the Ws array, and if the value is found, an index of the value in Ws is returned, otherwise, −1 is returned.

Step 4. The frequency spectrum array is attenuated using the merged interference frequency and deviation value.

Further, Step 4 specifically includes the following steps:
Step 4.1, acquiring a number N of elements in an interference frequency Ws, and initializing i=1;
Step 4.2, acquiring an i-th frequency Wi in the Ws and an i-th deviation value Di in the Ds;
Step 4.3, calculating an attenuation coefficient Ri using the deviation value Di;
Step 4.4, attenuating a frequency spectrum value Ai corresponding to each electromagnetic field component frequency Wi of the electromagnetic field, that is, Ai=Ai*Ri; and
Step 4.5, determining a value of i, in a case that i is equal to N, completing an attenuation of each frequency spectrum array, in a case that i is unequal to N, setting i=i+1, and proceeding to Step 4.2 for continuous processing.

Further, an attenuation frequency value of each of electromagnetic field components is the same, and an attenuation coefficient at the same frequency of each of electromagnetic field components is the same.

Further, Ri and Di have an inverse correlation, and calculation formula of Ri is Ri=10^{-Di}.

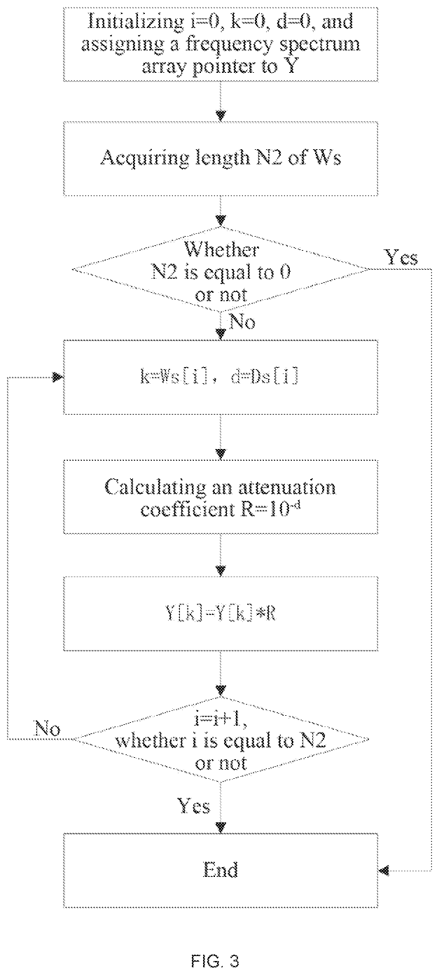

During specific implementation, the frequency spectrum arrays Y1, Y2, Y3 and Y4 can be processed using the values in Ws and Ds and the specific attenuation process until the attenuation is completed. The specific attenuation process for the frequency spectrum of a single component is shown in FIG. 3, where Y in the figure represents a frequency spectrum array pointer of a certain component, for example, if the second component is processed, Y=Y2.

Step 5. The electromagnetic time series data are recovered using the attenuated frequency spectrum array, so as to obtain a transform result.

During specific implementation, an inverse Fourier transform with a length of N can be performed on the frequency spectrum arrays Y1, Y2, Y3 and Y4, and the transform results can be stored in X1, X2, X3 and X4, respectively.

Step 6. The magnetotelluric impedance estimation is performed according to the transform result.

During specific implementation, conventional magnetotelluric impedance estimation can be performed according to the transform results, and parameters such as magnetotelluric impedance and apparent resistivity can be obtained.

In the magnetotelluric impedance estimation method according to this embodiment, all interference frequencies can be automatically identified by analyzing the power spectrum of each component of the electromagnetic signal, the deviation value of the interference frequency can be calculated, and then the frequency spectrum of each component can be synchronously attenuated on the interference frequency according to the deviation value to obtain a signal after filtering the interference. Finally, impedance estimation processing can be performed, thus improving the adaptability and accuracy of magnetotelluric impedance estimation.

The units involved in the embodiments described in the present disclosure can be realized by software or hardware.

It should be understood that various parts of the present disclosure can be implemented in hardware, software, firmware or a combination thereof.

The above is only the specific implementation of the present disclosure, but the scope of protection of the present disclosure is not limited thereto. Any change or substitution that can be easily thought by any person skilled in the art within the technical scope disclosed in the present disclosure should be covered by the scope of protection of the present disclosure. Therefore, the scope of protection of the present disclosure shall be subject to the appended claims.

What is claimed is:

1. A magnetotelluric impedance estimation method, comprising following steps:
Step 1, performing Fourier transform on electromagnetic time series data of a plurality of electromagnetic field components to obtain a frequency spectrum array corresponding to each of electromagnetic field components;
Step 2, identifying an interference frequency of each of electromagnetic field components according to the frequency spectrum array;
Step 3, merging the interference frequency and a deviation value;
Step 4, attenuating the frequency spectrum array using the merged interference frequency and deviation value;
Step 5, recovering the electromagnetic time series data using the attenuated frequency spectrum array, so as to obtain a transform result; and
Step 6, performing magnetotelluric impedance estimation according to the transform result.

2. The method according to claim 1, wherein the electromagnetic field components are at least two of Ex, Ey, Hx, Hy and Hz, wherein Ex is an electric field signal component in an X direction, Ey is an electric field signal component in a Y direction, Hx is a magnetic field signal component in the X direction, Hy is a magnetic field signal component in the Y direction, Hz is a magnetic field signal component in a Z direction, the X direction and the Y direction are horizontal directions and orthogonal to each other, and the Z direction is a vertical direction;
the electromagnetic time series data are sampling point data of each of electromagnetic field components collected according to a predetermined sampling rate.

3. The method according to claim 1, wherein Step 2 comprises following steps:
Step 2.1, computing a power spectrum array Pi(w) of each of electromagnetic field components according to the frequency spectrum array;
Step 2.2, filtering Pi(w) using a median filtering method to obtain a filtered data Pi1(w);
Step 2.3, calculating a difference ΔPi(w) between Pi(w) and Pi1(w); and
Step 2.4, selecting all interference frequency arrays Wr greater than a threshold Y0 from ΔPi(w), and recording ΔPi(w) corresponding to Wr in a deviation value Dr.

4. The method according to claim 1, wherein Step 3 comprises following steps:
Step 3.1, merging the interference frequency array Wr of each of electromagnetic field components into an array Ws by union, and only keeping one of same frequency values in Ws; and
Step 3.2, calculating a synthetic deviation value of each frequency according to an order of frequencies in the Ws array, and storing the synthetic deviation values in an array Ds in sequence.

5. The method according to claim 4, wherein the synthetic deviation value corresponds to a maximum deviation value of all components of the frequency.

6. The method according to claim 1, wherein Step 4 comprises following steps:
Step 4.1, acquiring a number N of elements in an interference frequency Ws, and initializing i=1;
Step 4.2, acquiring an i-th frequency Wi in the Ws and an i-th deviation value Di in the Ds;
Step 4.3, calculating an attenuation coefficient Ri using the deviation value Di;
Step 4.4, attenuating a frequency spectrum value Ai corresponding to each electromagnetic field component frequency Wi of the electromagnetic field, that is, Ai=Ai*Ri; and
Step 4.5, determining a value of i, in a case that i is equal to N, completing an attenuation of each frequency spectrum array, in a case that i is unequal to N, setting i=i+1, and proceeding to Step 4.2 for continuous processing.

7. The method according to claim 6, wherein an attenuation frequency value of each of electromagnetic field components is the same, and an attenuation coefficient at the same frequency of each of electromagnetic field components is the same.

8. The method according to claim 6, wherein Ri and Di have an inverse correlation, and calculation formula of Ri is Ri=10^{-Di}.
